(19) United States
(12) Patent Application Publication
(10) Pub. No.: US 2023/0404073 A1
(43) Pub. Date: Dec. 21, 2023

(54) METHOD, COMBINATION OR COMPOSITION FOR ENHANCED INSECTICIDAL, ACARICIDAL AND/OR NEMATICIDAL ACTIVITY

(71) Applicant: DANSTAR FERMENT AG, ZUG (CH)

(72) Inventors: Jean-Marc Sanchez, Daux (FR); Olivier Cor, Saint Jean de Boiseau (FR); Manuele Ricci, Perugia (IT)

(73) Assignee: DANSTAR FERMENT AG, ZUG (CH)

(21) Appl. No.: 18/252,348

(22) PCT Filed: Nov. 8, 2021
(86) PCT No.: PCT/EP2021/080965

§ 371 Date: May 9, 2023

(30) Foreign Application Priority Data
Nov. 9, 2020 (EP) 20306354.0
Nov. 9, 2020 (WO) PCT/EP2021/080965

(51) Int. Cl. A01N 35/02; A01N 43/40; A01P 7/04; A01N 47/40; A01N 43/90; A01P 7/02

(52) U.S. Cl. CPC A01N 35/02; A01N 43/40; A01P 7/04; A01N 47/40; A01N 43/90; A01P 7/02

(57) ABSTRACT

The present disclosure provides a method for controlling a pest or protecting a plant from a pest, said method comprising contacting soil, a pest, a plant or a plant part with (a) at least one insecticide, acaricide and/or nematicide and (b) glycine betaine. The present disclosure further provides a method for enhancing the efficacy of at least one insecticide, acaricide and/or nematicide, said method comprising contacting soil, a pest, a plant or a plant part with (a) at least one insecticide, acaricide and/or nematicide and (b) glycine betaine.

### TECHNOLOGICAL FIELD

The present disclosure relates to the use of glycine betaine for enhancing the effects of insecticides, acaricides and/or nematicides. It also relates to a combination of glycine betaine and insecticides, acaricides and/or nematicides, and to a method of controlling insects by the use of glycine betaine and insecticides, acaricides and/or nematicides.

### BACKGROUND

It is known that most synthetic pesticides such as insecticides, acaricides and/or nematicides could be harmful to human health, beneficial insects, and nontarget organisms. In addition, the development of resistance to these insecticides, acaricides and/or nematicides may induce higher concentrations of pesticides in the environment and in food. This has resulted in growing consumer pressure to reduce the use or at least the quantity of chemical (i.e. synthetic) pesticides. Thus, there is a need to manage food chain requirements while still allowing effective pest control.

Pesticide synergists have been used commercially and have contributed significantly to improve the efficacy of pesticides, particularly when problems of resistance have arisen.

These natural or synthetic chemicals, which increase the lethality and effectiveness of currently available pesticides, are by themselves considered nontoxic. The mode of action of the majority of synergists is to block the metabolic systems that would otherwise break down pesticide molecules.

The search for and the need of new molecules capable of increasing the potency of pesticides while allowing, if possible, a reduction of the amount of synthetic pesticides applied, is a constant need for developing alternative plant protection agents.

In view of this, a need exists for new pesticidal combinations or compositions that exhibit enhanced activity compared to existing pesticides compositions when, for example, the pesticide combinations or compositions are applied to an environment to control pests.

### BRIEF SUMMARY

The present disclosure is directed to a new use of glycine betaine to intensify the effect of pesticides (such as insecticides, acaricides and/or nematicides) on pests. Interestingly, glycine betaine is a natural product and it has no harmful or toxic effect on plants or animals.

In a first aspect, the present disclosure concerns a method for controlling a pest or protecting a plant from a pest, said method comprising contacting soil, a pest, a plant or a plant part with (a) at least one insecticide, acaricide and/or nematicide and (b) glycine betaine.

The present disclosure also provides a method for enhancing the efficacy of at least one insecticide, acaricide and/or nematicide, said method comprising contacting soil, a pest, a plant or a plant part with (a) at least one insecticide, acaricide and/or nematicide and (b) glycine betaine. Upon contact of the at least one insecticide, acaricide and/or nematicide and glycine betaine to soil, the pest, the plant or the plant part, the at least one insecticide, acaricide and/or nematicide may exhibit an increased pest control compared to contacting the at least one insecticide, acaricide and/or nematicide to soil, the pest, the plant or the plant part without glycine betaine.

Also provided is a method for reducing an amount of at least one insecticide, acaricide and/or nematicide applied to soil, a pest, a plant and/or a plant part needed to control a pest, comprising (a) applying to the soil, the pest, the plant and/or the plant part a combination of glycine betaine and the at least one insecticide, acaricide and/or nematicide. The at least one insecticide, acaricide and/or nematicide may be used or applied in an amount that is less than an amount of the at least one insecticide, acaricide and/or nematicide needed to control the pest in the absence of glycine betaine. Where the combination of glycine betaine and the at least one insecticide, acaricide and/or nematicide achieves substantially the same or greater insecticidal, acaricidal and/or nematicidal effect as would be achieved by application of the recommended dose of the at least one insecticide, acaricide and/or nematicide alone, the amount of the at least one insecticide, acaricide and/or nematicide may be less than a recommended dose of the at least one insecticide, acaricide and/or nematicide.

The methods may comprise applying the at least one insecticide, acaricide and/or nematicide to the soil, the pest, the plant and/or the plant part.

Further provided by the present disclosure is a method for manufacturing a composition which comprises mixing (a) at least one insecticide, acaricide and/or nematicide and (b) glycine betaine to obtain a composition comprising (a) at least one insecticide, acaricide and/or nematicide and (b) glycine betaine. Said method may further comprise mixing the (a) at least one insecticide, acaricide and/or nematicide and (b) glycine betaine with (c) a carrier to obtain a composition comprising (a) at least one insecticide, acaricide and/or nematicide, (b) glycine betaine and (c) the carrier. Said composition may be for controlling a pest. Where said composition is for controlling a pest, an amount of the at least one insecticide, acaricide and/or nematicide needed to control the pest may be less than an amount of the at least one insecticide, acaricide and/or nematicide needed to control the pest in the absence of glycine betaine.

Further provided by the present disclosure is a method of formulating a composition comprising glycine betaine and at least one insecticide, acaricide and/or nematicide for controlling a pest or protecting a plant from a pest, the method comprising preparing a composition comprising glycine betaine and an amount of the at least one insecticide, acaricide and/or nematicide needed to control the pest or protect the plant from the pest in the presence of glycine betaine, wherein the amount of the at least one insecticide, acaricide and/or nematicide needed to control the pest or protect the plant from the pest has been determined to be less than the amount of the at least one insecticide, acaricide and/or nematicide needed to control the pest or protect the plant from the pest in the absence of glycine betaine. In some embodiments, the method may further comprise determining an amount of the at least one insecticide, acaricide and/or nematicide needed to control the pest or protect the plant from the pest in the absence of glycine betaine. In some embodiments, the method may further comprise determining an amount of the at least one insecticide, acaricide and/or nematicide needed to control the pest or protect the plant from the pest in the presence of glycine betaine. In some embodiments, the method may further comprise comparing the amount of the at least one insecticide, acaricide and/or nematicide needed to control the pest or protect the plant from the pest in the absence of glycine betaine to the amount of the at least one insecticide, acaricide and/or nematicide needed to control the pest or protect the plant from the pest in the presence of glycine betaine.

The present disclosure also provides a composition for controlling a plant pest, wherein the composition comprises (a) at least one insecticide, acaricide and/or nematicide; and (b) glycine betaine. The composition may further comprise (c) a carrier. The composition may comprise an amount of the at least one insecticide, acaricide and/or nematicide that is less than an amount of the at least one insecticide, acaricide and/or nematicide need to control a pest in the absence of glycine betaine.

The present disclosure further provides use of an effective amount of (a) at least one insecticide, acaricide and/or nematicide and (b) glycine betaine. The use and effective amount is typically for controlling a pest or protecting a plant from a pest. The use may enhance the insecticidal, acaricidal and/or nematicidal activity of the at least one insecticide, acaricide and/or nematicide compared to the insecticidal, acaricidal and/or nematicidal activity of the at least one insecticide, acaricide and/or nematicide when used without glycine betaine. The use may reduce the amount of at least one insecticide, acaricide and/or nematicide needed for controlling a pest or protecting a plant from a pest.

Thus, the present disclosure provides use of an effective amount of glycine betaine for enhancing the insecticidal, acaricidal and/or nematicidal activity of at least one insecticide, acaricide and/or nematicide. The present disclosure further provides use of an effective amount of glycine betaine for reducing the amount of at least one insecticide, acaricide and/or nematicide needed for controlling a pest or protecting a plant from a pest. The present disclosure also provides use of an effective amount of (a) at least one insecticide, acaricide and/or nematicide and (b) glycine betaine, for controlling a pest or protecting a plant from a pest.

In any of the above-described methods, compositions or uses, the at least one insecticide, acaricide and/or nematicide may be Abamectin, Acephate, Acetamiprid, Acrinathrin, Alpha-Cypermethrin, Beta-Cyfluthrin, Bifenthrin, Buprofezin, Clothianidin, Chlorantraniliprole, Chlorfenapyr, Chlorpyrifos, Carbofuran, Cyantraniliprole, Cyenopyrafen, Cyflumentofen, Cyfluthrin, Cypermethrin, Deltamethrin, Diafenthiuron, Dinotefuran, Emamectin-benzoate, Ethiprole, Fenpyroximate, Fipronil, Flometoquin, Flubendiamide, Fluensulfone, Fluopyram, Flupyradifurone, Gamma-Cyhalothrin, Imidacloprid, Indoxacarb, Lambda-Cyhalothrin, Lufenuron, Metaflumizone, Methiocarb, Methoxyfenozide, Milbemectin, Profenofos, Pyflubumide, Pyrifluquinazone, Spinetoram, Spinosad, Spirodiclofen, Spiromesifen, Spirotetramate, Sulfoxaflor, Tebufenpyrad, Tefluthrin, Thiacloprid, Thiamethoxam, Thiodicarb, Triflumuron, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, 1-{2-fluoro-4-methyl-5-[(2,2,2-trifluorethyl)sulfinyl]phenyl}-3-(trifluoromethyl)-1H-1,2,4-triazol-5-amine or Afidopyropen. In an embodiment, the (i) the at least one insecticide, acaricide and/or nematicide may be abamectin; (ii) the at least one at least one insecticide, acaricide and/or nematicide may be acetamiprid; or (iii) the at least one at least one insecticide, acaricide and/or nematicide may be flupyradifurone.

In any of the above-described methods, compositions or uses, the at least one insecticide, acaricide and/or nematicide may be a synthetic insecticide, acaricide and/or nematicide. The at least one insecticide, acaricide and/or nematicide may be an externally applied insecticide, acaricide and/or nematicide. The at least one insecticide, acaricide and/or nematicide may have a molecular weight of less than 10000 daltons, optionally wherein the molecular weight of the at least one insecticide, acaricide and/or nematicide is less than 5000 daltons, such as less than 2500 daltons, less than 1000 daltons, less than 750 daltons or less than 500 daltons. In some aspects, the at least one insecticide, acaricide and/or nematicide is not a polypeptide.

In any of the above-described methods, compositions or uses, the pest may be an insect pest of the Order Hemiptera or Homoptera, or a mite pest. In an embodiment, the insect pest may belong to the species Dysaphis plantaginea, Trialeurodes vaporariorum or Myzus persicae. In another embodiment, the mite pest may belong to the species Tetranychus urticae.

In any of the above-described methods, compositions or uses, the (a) at least one insecticide, acaricide and/or nematicide and (b) glycine betaine may be used simultaneously or sequentially.

In any of the above-described methods, or uses, the at least one insecticide, acaricide and/or nematicide may be contacted with a plant or a plant part, wherein the plant is a tree, a fruit or a vegetable.

In specific embodiments of any of the above-described methods, compositions or uses, the glycine betaine is applied to soil, a pest, a plant or a plant part at a concentration of between at least 0.02% to 95% (weight/weight). In more specific embodiments of any of the above-described methods, compositions or uses, (i) the at least one insecticide, acaricide and/or nematicide may be abamectin and glycine betaine may be present at a concentration of between about 20% and 80% (w/w); (ii) the at least one insecticide, acaricide and/or nematicide may be acetamiprid and glycine betaine may be present at a concentration of between about 10% and 45% (w/w); or (iii) the at least one insecticide, acaricide and/or nematicide may be flupyradifurone and glycine betaine may be present at a concentration of between about 30% and 75% (w/w).

### DETAILED DESCRIPTION

The present disclosure provides pesticidal combinations or compositions which exhibit enhanced activity against insects, mites and/or nematodes comprising at least one insecticides, acaricides and/or nematicides and glycine betaine that enhances the pesticidal activity of the composition compared to a composition dissimilar only in not having the glycine betaine. The addition of glycine betaine even allows, amongst others, to reduce the application rates of insecticides, acaricides and/or nematicides and, thereby, provide a composition, combination or method, which at a reduced total amount of active compounds applied, has improved activity against insects, mites or nematodes. The composition, combination or method of the present disclosure results to a decrease in the amount of pesticide residues in the environment, an increase in the efficacy of pesticides (regardless of the dose used) and a reduction in the risk of resistance.

The present disclosure concerns the use of insecticides, acaricides and/or nematicides with glycine betaine in a simultaneous or sequential way to either plants, plant parts or soil which allow better control of pests (such as insects, mites and/or nematodes) than it is possible with the insecticides, acaricides and/or nematicides when used alone. By applying the glycine betaine in combination with insecticides, acaricides and/or nematicides according to the present disclosure, the activity against pests (such as insects, mites and/or nematodes) is increased.

The present disclosure provides an alternative way of increasing the effect of synthetic insecticides, acaricides and/or nematicides which does not use substances that are toxic or harmful to plants or animals. Surprisingly, glycine betaine, which is a natural product produced by certain plants, animals and microorganisms and which has no harmful or toxic effect on plants or animals, was found to produce such enhancing effect. The enhancing positive effect of glycine betaine on insecticides, acaricides and/or nematicides is to increase the killing effect and allow also the reduction of the total amount of synthetic active compound used. Glycine betaine is known in the art to protect plants against various stresses including salinity, drought, low and high temperatures and oxidative stress and, consequently, to improve plant growth and survival. Glycine betaine per se is not known to have insecticidal, acaricidal or nematicidal properties.

The present disclosure provides a method of reducing the use of insecticides, acaricides and/or nematicides, for example a synthetic insecticide, acaricide and/or nematicide, required for controlling a pest. The method may comprise applying to soil, a pest, a plant and/or a plant part to control a pest a combination of glycine betaine and at least one insecticide, acaricide and/or nematicide, so that the amount of the one insecticide, acaricide and/or nematicide is, for example, two times smaller and may be many fold more than the amount required to achieve the same control in the absence of said combination. Clearly, this reduction in the amount of the insecticide, acaricide and/or nematicide is of particular importance in order to decrease any detrimental environmental effects.

The present disclosure also provides a combination of components for reducing the amount of insecticides, acaricides and/or nematicides required for controlling pests, wherein said reduced dose of insecticides, acaricides and/or nematicides, and glycine betaine are present in a form that can be delivered simultaneously, sequentially or separately from each to soil, a pest, a plant, or a plant part. By the term “combination” as used herein, the term means two or more substances in proximity to one another and/or used together, regardless of whether a carrier is included. The composition of insecticides, acaricides and/or nematicides, and glycine betaine may be considered a combination. The present disclosure also provides use of an effective amount of glycine betaine for reducing the amount of at least one insecticide, acaricide and/or nematicide needed for controlling a pest or protecting a plant from a pest, as described herein.

The amount of the at least one insecticide, acaricide and/or nematicide may be at least about 5%, at least about 10%, at least about 20%, at least about 30%, at least about 40%, or at least about 50%, at least about 60%, at least about 70%, at least about 80%, at least about 90%, or at least about 95% less than the amount of the at least one insecticide, acaricide and/or nematicide needed to control the pest in the absence of glycine betaine.

The amount of the least one insecticide, acaricide and/or nematicide may be replaced by an amount of glycine betaine, wherein the amount of the least one insecticide, acaricide and/or nematicide replaced is from about 5 wt % to about 95 wt %, from about 20 wt % to about 80 wt %, from about 35 wt % to about 65 wt %, from about 45 wt % to about 55 wt %, or about 50 wt %, of the recommended dose of the at least one insecticide, acaricide and/or nematicide. Alternatively, the amount of the at least one insecticide, acaricide and/or nematicide is at least about 5%, at least about 10%, at least about 20%, at least about 30%, at least about 40%, or at least about 50%, at least about 60%, at least about 70%, at least about 80%, at least about 90%, or at least about 95% less than the recommended dose for the at least one insecticide, acaricide and/or nematicide.

The combination of the present disclosure may be obtained by combining glycine betaine with a reduced amount of at least one insecticide, acaricide and/or nematicide as long as the insecticidal, acaricidal and/or nematicidal action is achieved. As used herein, the term “recommended dose” is synonym of a homologated dose or an approved dose and means the amount of formulated product of an insecticide, acaricide and/or nematicide applied as recommended by authorities. In an embodiment, the amount of insecticide, acaricide and/or nematicide applied is within a range of from about 10% to about 90% of the recommended dose, from about 15% of the recommended dose to about 85% of the recommended dose, from about 20% of the recommended dose to about 80% of the recommended dose, from about 25% of the recommended dose to about 75% of the recommended dose, from about 30% of the recommended dose to about 70% of the recommended dose or from about 40% of the recommended dose to about 60% of the recommended dose. In some embodiments, the amount of insecticide, acaricide and/or nematicide applied corresponds to at least about 10% of the recommended dose, at least about 15% of the recommended dose, at least about 20% of the recommended dose, at least about 25% of the recommended dose, at least about 30% of the recommended dose, at least about 35% of the recommended dose, at least about 40% of recommended dose, at least about 50% of the recommended dose, at least about 55% of the recommended dose, at least about 60% of the recommended dose, at least about 65% of the recommended dose, at least about 70% of the recommended dose, at least about 75% of the recommended dose, at least about 80% of the recommended dose, at least about 85% of the recommended dose or at least about 90% of the recommended dose and is selected to maintain the insecticidal, acaricidal and/or nematicidal properties of the combination. It is expected than even lower concentrations of insecticide, acaricide and/or nematicide may be effectively combined with glycine betaine while maintaining the insecticidal, acaricidal and/or nematicidal effective properties of the combination. In an embodiment, glycine betaine is used to increase the effect of synthetic insecticides and/or acaricides. Glycine betaine (N,N,N-trimethyl glycine) is commercially available for example under the trademark of IntraCell®, Greenstim®, Bluestim®, Osmopro® or LALSTIM Osmo® (Lallemand). Other betaine products, such as betaine monohydrate, betaine hydrochloride and raw betaine liquids, are also commercially available and they can be used for the purposes of the present disclosure.

In the context of the present disclosure, any compound with a pesticidal activity can be used in conjunction with glycine betaine. As used herein, the term “pesticidal” refers to the property of a substance to exhibit activity against pest such as insects, mites and/or nematodes.

In an embodiment, any compound with an insecticidal activity can be used in conjunction with glycine betaine. As used herein, the term “insecticidal” or “insecticide” refers to the property of a substance to increase mortality or inhibit growth rate of insects in the class “insecta”. As used herein, the general term “insects” includes any form or stage of an organisms such as eggs, larvae, nymphs or adult stage.

In an embodiment, any compound with an acaricide activity can be used in conjunction with glycine betaine. As used herein, the term “acaricidal” or “acaricide” refers to the property of a substance to increase mortality or inhibit growth rate of the arachnid which belongs to the class Arachnida and subclass Acari.

In an embodiment, any compound with a nematicide activity can be used in conjunction with glycine betaine. As used herein, the term “nematicidal” or “nematicide” refers to the property of a substance to increase mortality or inhibit growth rate of nematodes. In general, the term “nematode” comprises eggs, larvae, juvenile and mature forms of said organism.

According to an embodiment, examples of insecticides, acaricides and/or nematicides that could be used in the context of the present disclosure are:

Abamectin, Acephate, Acetamiprid, Acrinathrin, Alpha-Cypermethrin, Beta-Cyfluthrin, Bifenthrin, Buprofezin, Clothianidin, Chlorantraniliprole, Chlorfenapyr, Chlorpyrifos, Carbofuran, Cyantraniliprole, Cyenopyrafen, Cyflumentofen, Cyfluthrin, Cypermethrin, Deltamethrin, Diafenthiuron, Dinotefuran, Emamectin-benzoate, Ethiprole, Fenpyroximate, Fipronil, Flometoquin, Flubendiamide, Fluensulfone, Fluopyram, Flupyradifurone, Gamma-Cyhalothrin, Imidacloprid, Indoxacarb, Lambda-Cyhalothrin, Lufenuron, Metaflumizone, Methiocarb, Methoxyfenozide, Milbemectin, Profenofos, Pyflubumide, Pyrifluquinazone, Spinetoram, Spinosad, Spirodiclofen, Spiromesifen, Spirotetramate, Sulfoxaflor, Tebufenpyrad, Tefluthrin, Thiacloprid, Thiamethoxam, Thiodicarb, Triflumuron, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, 1-{2-fluoro-4-methyl-5-[(2,2,2-trifluorethyl)sulfinyl]phenyl}-3-(trifluoromethyl)-1H-1,2,4-triazol-5-amine or Afidopyropen. The insecticide, acaricide and/or nematicide can be used alone with glycine betaine or in combination (i.e. at least two insecticides, acaricide and/or nematicide or a combination of at least one insecticide, acaricide and/or nematicide).

According to the present disclosure, the composition or combination comprises at least one insecticide, acaricide and/or nematicide and glycine betaine in an effective amount. The combination of the present disclosure results in a pesticidal (i.e. an insecticidal, acaricidal and/or nematicidal) activity that is greater than the pesticide(s) used alone.

In an embodiment, the present disclosure relates the combination or a composition comprising or consisting of abamectin and glycine betaine, acetamiprid and glycine betaine or flupyradifurone and glycine betaine.

To improve the effect of pesticides, such as insecticide, acaricide and/or nematicide, glycine betaine can be added to the insecticide(s), acaricide(s) and/or nematicide(s) or an insecticide, acaricide and/or nematicide mixture during the use, e.g. by adding glycine betaine to the tank-mix. It is also possible to use a combination of glycine betaine and insecticide(s), acaricide(s) and/or nematicide(s) in the form of a commercially available (ready-for-use) product.

Alternatively, glycine betaine and insecticide(s), acaricide(s) and/or nematicide(s) can be applied simultaneously or sequentially (or consecutively), i.e. one after the other within a reasonably short period, such as a few hours or days, e.g. 1 hour to 7 days. The order of application is irrelevant in the context of the present disclosure, glycine betaine can be added either before or after the insecticide(s), acaricide(s) and/or nematicide(s). For example, if the glycine betaine and insecticide(s), acaricide(s) and/or nematicide(s) are applied in a sequential manner, the following method can be used: applying first the glycine betaine and secondly applying the insecticide(s), acaricide(s) and/or nematicide(s) to the same plants, plant parts or soil.

In one embodiment of the present disclosure, suitable quantity of glycine betaine used with or added to at least one pesticide such as an insecticide, acaricide and/or nematicide is at least 25 g/ha (hectare), 50 g/ha, such as 50-7500 g/ha, 50-2500 g/ha, 50-1500 g/ha; at least 100 g/ha, at least 150 g/ha, at least 200 g/ha, at least 250 g/ha, at least 300 g/ha, at least 350 g/ha, at least 400 g/ha, at least 450 g/ha, at least 500 g/ha, at least 600 g/ha, at least 700 g/ha, at least 800 g/ha, at least 900 g/ha or at least 1000 g/ha. In an embodiment, suitable quantity of glycine betaine used with or added to at least one pesticide such as an insecticide, acaricide and/or nematicide is at least between 200 g/ha to 500 g/ha.

The amount of glycine betaine which is used or employed in combination with at least one pesticide, such as an insecticide, acaricide and/or nematicide, depends on the final formulation as well as size or type of the plant, plant parts, seeds or soil to be treated. Usually, glycine betaine to be employed or used according to the present disclosure is present in about 0.02% to about 95% (w/w), of its solo-formulation or combined-formulation (i.e. a combined use) with the at least one insecticide acaricide and/or nematicide.

Also the amount of the at least one pesticide such as an insecticide and/or an acaricide which is used or employed in combination with the glycine betaine depends on the final formulation as well as size or type of the plant, plant parts or soil to be treated. Usually, the at least one pesticide such as an insecticide, acaricide and/or nematicide to be employed or used according to the invention is present in about 0.02% to about 95% (w/w) of its solo-formulation or combined-formulation with glycine betaine.

In an embodiment, the combination or composition of the present disclosure comprises or consists of abamectin and glycine betaine wherein the concentration of glycine betaine is between about 20% and 80% (w/w). In another embodiment, the combination or composition of the present disclosure comprises or consists of acetamiprid and glycine betaine wherein the concentration of glycine betaine is between about 10% and 45% (w/w). In another example, the combination or a composition comprises or consists of flupyradifurone and glycine betaine wherein the concentration of glycine betaine is between about 30% and 75% (w/w).

The application rate of composition to be employed or used according to the present disclosure may vary. The skilled person is able to find the appropriate application rate by way of routine experiments.

Any suitable methods known in the art can be used to apply the composition or combination comprising glycine betaine with the at least one pesticide, such as an insecticide, acaricide or nematicide. Compounds can be applied to either soil plants or plant parts, either separately or together with other plant-protecting substances, herbicides, fungicides or nutrients, such as anti-fungal agents, and micronutrients. Even the time of a treatment according to the present disclosure may vary: the treatment can be performed either before sowing, or before or after the emergence of plants. The suitable time is defined by criteria commonly used in the field, taking notice of e.g. the crop plant, the insecticides, acaricides and/or nematicides used, and the cultivation conditions. The glycine betaine and the at least one insecticide, acaricide and/or nematicide are administered to the plants either simultaneously or sequentially. It is considered preferable to perform the treatment at an early stage of growth. The treatment, however, can be repeated several times, if desired.

In the methods of the present disclosure, the methods may comprise a step of applying the insecticide, acaricide and/or nematicide to soil, a pest, a plant and/or a plant part, such as to soil, a plant or a plant part. In the present disclosure, the insecticide, acaricide and/or nematicide may be an exogenously applied insecticide, acaricide and/or nematicide. The insecticide, acaricide and/or nematicide may be externally applied. The insecticide, acaricide and/or nematicide may have a molecular weight of less than 10000 daltons, such as less than 5000 daltons, such as less than 2500 daltons, less than 1000 daltons, less than 750 daltons or less than 500 daltons. In some embodiments of the methods and uses described herein, the insecticide, acaricide and/or nematicide is not a polypeptide. As used herein, the term ‘polypeptide’ refers to a compound comprising a series of amino acids joined by peptide bonds. The term ‘polypeptide’ includes short peptide sequences (e.g. less than 20 amino acids in length), longer peptides, and proteins.

The present combination or composition is active against normally sensitive and resistant species and against all or some stages of development. The abovementioned pests include:
pests from the phylum Arthropoda, especially from the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., Epitrimerus pyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp. (e.g. Tetranychus urticae), Trombicula alfreddugesi, Vaejovis spp., Vasates lycopersici;
in particular clover mite, brown mite, hazelnut spider mite, asparagus spider mite, brown wheat mite, legume mite, oxalis mite, boxwood mite, Texas citrus mite, Oriental red mite, citrus red mite, European red mite, yellow spider mite, fig spider mite, Lewis spider mite, six-spotted spider mite, Willamette mite Yuma spider mite, web-spinning mite, pineapple mite, citrus green mite, honey-locust spider mite, tea red spider mite, southern red mite, avocado brown mite, spruce spider mite, avocado red mite, Banks grass mite, carmine spider mite, desert spider mite, vegetable spider mite, tumid spider mite, strawberry spider mite, two-spotted spider mite, McDaniel mite, Pacific spider mite, hawthorn spider mite, four-spotted spider mite, Schoenei spider mite, Chilean false spider mite, citrus flat mite, privet mite, flat scarlet mite, white-tailed mite, pineapple tarsonemid mite, West Indian sugar cane mite, bulb scale mite, cyclamen mite, broad mite, winter grain mite, red-legged earth mite, filbert big-bud mite, grape erineum mite, pear blister leaf mite, apple leaf edgeroller mite, peach mosaic vector mite, alder bead gall mite, Perian walnut leaf gall mite, pecan leaf edgeroll mite, fig bud mite, olive bud mite, citrus bud mite, litchi erineum mite, wheat curl mite, coconut flower and nut mite, sugar cane blister mite, buffalo grass mite, bermuda grass mite, carrot bud mite, sweet potato leaf gall mite, pomegranate leaf curl mite, ash sprangle gall mite, maple bladder gall mite, alder erineum mite, redberry mite, cotton blister mite, blueberry bud mite, pink tea rust mite, ribbed tea mite, grey citrus mite, sweet potato rust mite, horse chestnut rust mite, citrus rust mite, apple rust mite, grape rust mite, pear rust mite, flat needle sheath pine mite, wild rose bud and fruit mite, dryberry mite, mango rust mite, azalea rust mite, plum rust mite, peach silver mite, apple rust mite, tomato russet mite, pink citrus rust mite, cereal rust mite, rice rust mite;
from the class Chilopoda, for example, Geophilus spp., Scutigera spp.;
from the order or the class Collembola, for example, Onychiurus armatus;
from the class Diplopoda, for example, Blaniulus guttulatus;
from the class Insecta, e.g. from the order Blattodea, for example, Blattella asahinai, Blattella germanica, Blatta orientalis, Leucophaea maderae, Panchlora spp., Parcoblatta spp., Periplaneta spp., Supella longipalpa;
from the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp., Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psylliodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., Zabrus spp.;
preferably from Banded cucumber beetle (Diabrotica balteata), Northern corn rootworm (Diabrotica barberi), Southern corn rootworm (Diabrotica undecimpunctata howardi), Western cucumber beetle (Diabrotica undecimpunctata tenella), Western spotted cucumber beetle (Diabrotica undecimpunctata undecimpunctata), Western corn rootworm (Diabrotica virgifera virgifera), Mexican corn rootworm (Diabrotica virgifera zeae);
from the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophaga, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp., Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., Tipula spp.;
from the order Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.; from the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma piri, Aphis spp., Arboridia apicalis, Arytainilla spp., Aspidiella spp., Aspidiotus spp., Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp. (e.g. Dysaphis plantaginea), Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp. (e.g. Myzus persicae), Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphum spp., Saissetia spp., Scaphoideus titanus, Schizaphis graminum, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, Zygina spp.;
from the order Hymenoptera, for example, Acromyrmex spp., Athalia spp., Atta spp., Diprion spp., Hoplocampa spp., Lasius spp., Monomorium pharaonis, Sirex spp., Solenopsis invicta, Tapinoma spp., Urocerus spp., Vespa spp., Xeris spp.;
from the order Isopoda, for example, Armadillidium vulgare, Oniscus asellus, Porcellio scaber; from the order Isoptera, for example, Coptotermes spp., Cornitermes cumulans, Cryptotermes spp., Incisitermes spp., Microtermes obesi, Odontotermes spp., Reticulitermes spp.; from the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Chematobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp., Spodoptera praefica, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, Virachola spp.;
from the order Orthoptera or Saltatoria, for example, Acheta domesticus, Dichroplus spp., Gryllotalpa spp., Hieroglyphus spp., Locusta spp., Melanoplus spp., Schistocerca gregaria;
from the order Phthiraptera, for example, Damalinia spp., Haematopinus spp., Linognathus spp., Pediculus spp., Ptirus pubis, Trichodectes spp.;
from the order Psocoptera for example Lepinatus spp., Liposcelis spp.;
from the order Siphonaptera, for example, Ceratophyllus spp., Ctenocephalides spp., Pulex irritans, Tunga penetrans, Xenopsylla cheopsis;
from the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, Thrips spp.;
from the order Zygentoma (=Thysanura), for example, Ctenolepisma spp., Lepisma saccharina, Lepismodes inquilinus, Thermobia domestica;
from the class Symphyla, for example, Scutigerella spp.;
pests from the phylum Mollusca, especially from the class Bivalvia, for example, Dreissena spp., and
from the class Gastropoda, for example, Arion spp., Biomphalaria spp., Bulinus spp., Deroceras spp., Galba spp., Lymnaea spp., Oncomelania spp., Pomacea spp., Succinea spp.; animal pests from the phylums Plathelminthes and Nematoda, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; phytoparasitic pests from the phylum Nematoda, for example, Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp., Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp., Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp., Hirschmaniella spp, Tetylenchus spp.

The pest is preferably from the order Hemiptera, more preferably, the suborder Homoptera discussed above.

In some embodiments of the methods and uses described herein, the pest is from the class Arachnida, Chilopoda, Collembola or Diplopoda, or from the order Blattodea, Coleoptera, Diptera, Heteroptera, Homoptera, Hemiptera, Isopoda, Isoptera, Orthoptera, Phthiraptera, Psocoptera, Siphonaptera, Thysanoptera or Zygentoma, or from the phylum Mollusca, Plathelminthes or Nematoda.

The compositions and combinations of the present disclosure may be applied to a plant or a plant part, or to the soil. Typically, the soil is in the vicinity of a plant. The compositions and combinations of the present disclosure may be applied to a range of plant matter. The plant may be a monocotyledonous plant or a dicotyledonous plant. Monocotyledonous plants include wheat, barley, rice, oats, rye, sugar cane, corn, and non-graminaceous monocotyledonous plants (for example, asparagus). Preferably, the plant is a dicotyledonous plant. Dicotyledonous plants include fruit, vegetables and leguminous plants, such as; fruit and stone fruit trees, such as apple trees, pear trees, vines (e.g. cucumbers, zucchinis and tomatoes), grapes, cherry trees, plum trees, apricot trees, peach trees, citrus trees and the like. The plant may be selected from trees, vegetables, fruits and vines. The plant may be selected from trees, vegetables and fruits. The plant may be selected from fruit and stone fruit trees and vines. In some embodiments of the methods and uses described herein, the plant is not a grass, corn, cucumber, basil and or cotton (specifically Bt transgenic cotton or NuCotton 37). In some embodiments of the methods and uses described herein, the plant is not corn or cotton.

The word “comprising” in the claims may be replaced by “consisting essentially of” or with “consisting of,” according to standard practice in patent law.

The following example serves to further describe and define the invention and is not intended to limit the invention in any way.

### Example 1: Combination of Glycine Betaine and Flupyradifurone Against Aphids

Tests were conducted to study the efficacy of the addition of glycine betaine to flupyradifurone in tank mix against Aphids (Aphis sp.) on apples. The trials were conducted under field conditions.

Field assessments were done before application of the treatment (0 DAA) to record pest population and create the blocks according to the infestation.

Trees were sprayed with a combination of glycine betaine (Intracell, Lallemand) and flupyradifurone (Sivanto Prime, Bayer).

The trials were set up in a fully randomized block design with 4 replicates and the untreated control, included. The following sprayable treatments were tested: (1) untreated; (2) Sivanto Prime 0.6 l/ha (higher dose that could be used based on recommendations); (3) Sivanto Prime 0.6 l/ha+glycine betaine 300 g/ha; (4) Sivanto Prime 0.12 l/ha (20% of recommended dose); or (5) Sivanto Prime 0.12 l/ha+glycine betaine 300 g/ha. One application was performed during development of fruits.

Aphids belonging to the species Dysaphis plantaginea were recorded on 25 labelled shoots per plot at each assessment timing: 0 DAA, 3 DAA, 7 DAA, 14 DAA and 21 DAA.

TABLE 1
Effect of the combination of glycine betaine and
flupyradifurone on aphid mortality (Abbott %)

| | 0DAA | | | | | | |
|---|---|---|---|---|---|---|---|
| | (number | | | | | | |
| | of insects | | | | | | |
| Insect | in 25 | | | | | SUM | Increase |
| control | shoots) | 3DAA | 7DAA | 14DAA | 21DAA | efficacy | % |
| Untreated | 0.5 | 0.59 | 0.88 | 1.47 | 2.43 | | |
| (number of | | | | | | | |
| insects in 25 | | | | | | | |
| shoots) | | | | | | | |
| Sivanto | 0.2 | 98.51 | 95.51 | 72.86 | 67.71 | 334.59 | |
| 0.6 l/ha | | | | | | | |
| Sivanto | 0.7 | 100 | 92.59 | 79.12 | 73.77 | 345.48 | 3.25 |
| 0.6 l/ha + | | | | | | | |
| GB 300 | | | | | | | |
| g/ha | | | | | | | |
| Sivanto | 0.7 | 80.05 | 78.88 | 54.33 | 14.3 | 227.56 | |
| 0.12 l/ha | | | | | | | |
| Sivanto | 0.6 | 87.47 | 87.68 | 77.99 | 56.73 | 309.87 | 36.17 |
| 0.12 l/ha + | | | | | | | |
| GB 300 | | | | | | | |
| g/ha | | | | | | | |

TABLE 2
Effect of the addition of glycine betaine to flupyradifurone
on aphid mortality at each of the assessment performed

| | Assessment | High dose | | | | Low dose | | | | Average % |
|---|---|---|---|---|---|---|---|---|---|---|
| Target | type | 1st ass | 2nd ass | 3rd ass | 4th ass | 1st ass | 2nd ass | 3rd ass | 4th ass | of+ |
| Adults | Insects | + | − | + | + | + | + | + | + | 87.5% |

“+” means that an improvement of the efficacy has been observed;
“=” means that no improvement in efficeny has been observed;
and “−” means that a negative effect has been observed.

As shown in Tables 1 and 2, the combined use of glycine betaine and flupyradifurone (at 20% of the recommended dose) results in a mortality of aphids of 36.17% greater compared to a composition dissimilar only in not having the glycine betaine. Overall, the average increase in mortality was 19.71% compared to the use of the flupyradifurone alone. Further, the results presented in Table 2 indicate that an improvement of the insecticide activity by the addition of glycine betaine was observed in 87, 5% of the assessments done.

### Example 2: Combination of Glycine Betaine and Flupyradifurone Against Whiteflies

Tests were conducted to study the efficacy of the addition of glycine betaine to flupyradifurone in tank mix against white flies (Trialeurodes vaporariorum) on zucchinis. The trials were conducted in greenhouse.

Plants were sprayed with a combination of glycine betaine (Intracell, Lallemand) and flupyradifurone (Sivanto Prime, Bayer) at BBCH 75 (5th fruit on main stem has reached typical size and form).

The trials were set up in a fully randomized block design with 4 replicates and the untreated control, included. Each plot contained ten plants. The following sprayable treatments were tested: (1) untreated; (2) Sivanto Prime 0.56 l/ha (higher dose that could be used based on recommendations); (3) Sivanto Prime 0.56 l/ha+glycine betaine 300 g/ha; (4) Sivanto Prime 0.28 l/ha (50% of recommended dose); (5) Sivanto Prime 0.28 l/ha+glycine betaine 300 g/ha; (6) Sivanto Prime 0.14 l/ha (20% of recommended dose); or (7) Sivanto Prime 0.14 l/ha+glycine betaine 300 g/ha.

Immatures and adults T. vaporariorum were evaluated on 25 labelled leaves per plot. When immature population was high, larvae and/or nymphs and pupae were enumerated on ten leaves/plot. Five assessments were conducted: 0 DBA, 3 DAA, 7 DAA, 14 DAA and 21 DAA.

TABLE 3
Effect of the combination of glycine betaine and flupyradifurone on
immature white fly incidence (% on leaves with at least 1 insect)

| | 0DAA | | | | | | |
|---|---|---|---|---|---|---|---|
| | (number of | | | | | | |
| | leaves with | | | | | | |
| Incidence | at least 1 | | | | | | |
| immature | insect/25 | | | | | SUM | Increase |
| (Abbott) | leaves) | 3DAA | 7DAA | 14DAA | 21DAA | efficacy | % |
| Untreated | 22 | 25 | 29 | 33 | 48 | | |
| (number of | | | | | | | |
| leaves with | | | | | | | |
| at least 1 | | | | | | | |
| insect/25 | | | | | | | |
| leaves) | | | | | | | |
| Sivanto | 15 | 93.75 | 87.5 | 81.19 | 69.4 | 331.84 | |
| 0.56 l/ha | | | | | | | |
| Sivanto | 18 | 96.43 | 87.5 | 90.63 | 72.97 | 347.53 | 4.73 |
| 0.56 l/ha + | | | | | | | |
| GB 300 | | | | | | | |
| g/ha | | | | | | | |
| Sivanto | 15 | 79.76 | 78.75 | 72.22 | 68.32 | 299.05 | |
| 0.28 l/ha | | | | | | | |
| Sivanto | 13 | 83.48 | 87.68 | 81.94 | 67.83 | 320.93 | 7.32 |
| 0.28 l/ha + | | | | | | | |
| GB 300 | | | | | | | |
| g/ha | | | | | | | |
| Sivanto | 19 | 65.77 | 59.91 | 57.64 | 40.12 | 223.44 | |
| 0.14 l/ha | | | | | | | |
| Sivanto | 14 | 73.07 | 68.04 | 57.64 | 41.4 | 240.15 | 7.48 |
| 0.14 l/ha + | | | | | | | |
| GB 300 | | | | | | | |
| g/ha | | | | | | | |

TABLE 4
Effect of the combination of glycine betaine and flupyradifurone
on adult white fly incidence (% of leaves with at least 1 insect)

| | 0DAA | | | | | | |
|---|---|---|---|---|---|---|---|
| | (number | | | | | | |
| | of leaves | | | | | | |
| | with at | | | | | | |
| Incidence | least 1 | | | | | | |
| adults | insect/25 | | | | | SUM | Increase |
| Abbott | leaves) | 3DAA | 7DAA | 14DAA | 21DAA | efficacy | % |
| Untreated | 16 | 20 | 22 | 33 | 46 | | |
| (number of | | | | | | | |
| leaves with | | | | | | | |
| at least 1 | | | | | | | |
| insect/25) | | | | | | | |
| Sivanto | 9 | 100 | 93.75 | 90.8 | 67.54 | 352.09 | |
| 0.56 l/ha | | | | | | | |
| Sivanto | 14 | 93.75 | 95 | 93.75 | 69.69 | 352.19 | 0.03 |
| 0.56 l/ha + | | | | | | | |
| GB 300 | | | | | | | |
| g/ha | | | | | | | |
| Sivanto | 12 | 81.25 | 73.33 | 75.36 | 60.14 | 290.08 | |
| 0.28 l/ha | | | | | | | |
| Sivanto | 9 | 89.58 | 90.83 | 78.48 | 68.73 | 327.62 | 12.94 |
| 0.28 l/ha + | | | | | | | |
| GB 300 | | | | | | | |
| g/ha | | | | | | | |

TABLE 5
Effect of the combination of glycine betaine and flupyradifurone
on the severity of mortality of immature white flies (Abbott %)

| | 0DAA | | | | | | |
|---|---|---|---|---|---|---|---|
| Severity | (number of | | | | | | |
| immature | insects in | | | | | SUM | Increase |
| Abbott | 25 leaves) | 3DAA | 7DAA | 14DAA | 21DAA | efficacy | % |
| Untreated | 0.81 | 0.99 | 1.62 | 3.22 | 6.48 | | |
| (number | | | | | | | |
| of insects | | | | | | | |
| in 25 | | | | | | | |
| leaves) | | | | | | | |
| Sivanto | 0.61 | 95.45 | 80.36 | 91.72 | 84.02 | 351.55 | |
| 0.56 l/ha | | | | | | | |
| Sivanto | 0.89 | 98.53 | 94.64 | 95.06 | 86.69 | 374.92 | 6.65 |
| 0.56 l/ha + | | | | | | | |
| GB 300 | | | | | | | |
| g/ha | | | | | | | |
| Sivanto | 0.71 | 64.6 | 77.77 | 86.8 | 80.84 | 310.01 | |
| 0.28 l/ha | | | | | | | |
| Sivanto | 0.57 | 82.4 | 87.73 | 92.13 | 81.57 | 343.83 | 10.91 |
| 0.28 l/ha + | | | | | | | |
| GB 300 | | | | | | | |
| g/ha | | | | | | | |
| Sivanto | 0.92 | 64.27 | 55.51 | 77.83 | 65.55 | 263.16 | |
| 0.14 l/ha | | | | | | | |
| Sivanto | 0.7 | 73.68 | 56.18 | 78.72 | 65.92 | 274.5 | 4.31 |
| 0.14 l/ha + | | | | | | | |
| GB 300 | | | | | | | |
| g/ha | | | | | | | |

TABLE 6
Effect of the combination of glycine betaine and flupyradifurone
on the severity of mortality of adult white flies (Abbott %)

| | 0DAA | | | | | | |
|---|---|---|---|---|---|---|---|
| | (number of | | | | | | |
| Severity | insects in | | | | | SUM | Increase |
| adults | 25 leaves) | 3DAA | 7DAA | 14DAA | 21DAA | efficacy | % |
| Untreated | 0.3 | 0.35 | 0.8 | 1.53 | 3.35 | | |
| (number | | | | | | | |
| of insects | | | | | | | |
| in 25 | | | | | | | |
| leaves) | | | | | | | |
| Sivanto | 0.22 | 100 | 86.54 | 90.6 | 82.61 | 359.75 | |
| 0.56 l/ha | | | | | | | |
| Sivanto | 0.32 | 97.22 | 96.53 | 94.76 | 83.62 | 372.13 | 3.44 |
| 0.56 l/ha + | | | | | | | |
| GB 300 | | | | | | | |
| g/ha | | | | | | | |
| Sivanto | 0.27 | 73.02 | 85.2 | 87.2 | 76.92 | 322.34 | |
| 0.28 l/ha | | | | | | | |
| Sivanto | 0.21 | 85.71 | 88.89 | 89.52 | 79.46 | 343.58 | 6.59 |
| 0.28 l/ha + | | | | | | | |
| GB 300 | | | | | | | |
| g/ha | | | | | | | |
| Sivanto | 0.29 | 67.56 | 57.48 | 72.56 | 59.78 | 257.38 | |
| 0.14 l/ha | | | | | | | |
| Sivanto | 0.27 | 67.56 | 69.87 | 72.08 | 62.04 | 271.55 | 5.51 |
| 0.14 l/ha + | | | | | | | |
| GB 300 | | | | | | | |
| g/ha | | | | | | | |

TABLE 7
Effect of the addition of glycine betaine to flupyradifurone
on whiteflies mortality at each of the assessment performed

| | Assessment | High dose | | | | Medium dose | | | | Low dose | | | | Average |
|---|---|---|---|---|---|---|---|---|---|---|---|---|---|---|
| Target | type | 1 ass | 2 ass | 3 ass | 4 ass | 1 ass | 2 ass | 3 ass | 4 ass | 1 ass | 2 ass | 3 ass | 4 ass | % of+ |
| WF | Incidence | − | + | + | + | + | + | + | + | − | + | − | + | 75% |
| Adults | | | | | | | | | | | | | | |
| WF | Incidence | + | = | + | + | + | + | + | − | + | + | = | + | 75% |
| Immatur | | | | | | | | | | | | | | |
| WF | N. insects | − | + | + | + | + | + | + | + | = | + | = | + | 75% |
| Adults | | | | | | | | | | | | | | |
| WF | N. insects | + | + | + | + | + | + | + | + | + | + | + | + | 100% |
| Immatur | | | | | | | | | | | | | | |
| | | | | | | | | | | | | | | 81% |

“+” means that an improvement of efficacy has been observed;
“=” means that no improvement in efficacy has been observed;
and “−” means that a negative effect has been observed.

The results show in Tables 3 to 7 that an addition of glycine betaine to flupyradifurone made the control measures against white flies more effective. Further, the results presented in Table 7 indicate that an improvement of the insecticide activity by the addition of glycine betaine was observed in 81% of the assessments done, all treatments taken together.

### Example 3: Combination of Glycine Betaine and Acetamiprid Against Whiteflies

Tests were conducted to study the efficacy of the addition of glycine betaine to acetamiprid in tank mix against white flies (Trialeurodes vaporariorum) on cucumbers. The trials were conducted in greenhouse.

Plants were sprayed with a combination of glycine betaine (Intracell, Lallemand) and acetamiprid (Epik, Sipcam), at BBCH 71 (1st fruit on main stem has reached typical size and form).

The trials were set up in a fully randomized block design with 4 replicates and the untreated control, included. Each plot contained ten plants. The following sprayable treatments were tested: (1) untreated; (2) Epik 2 l/ha (higher dose that could be used based on recommendations); (3) Epik 2 l/ha+glycine betaine 300 g/ha; (4) Epik 1 l/ha (50% of recommended dose); (5) Epik 1 l/ha+glycine betaine 300 g/ha; (6) Epik 0.5 l/ha (20% of recommended dose); or (7) Epik 0.5 l/ha+glycine betaine 300 g/ha.

Immatures and adults T. vaporariorum were evaluated on 25 labelled leaves per plot. When immature population was high, larvae and/or nymphs and pupae were enumerated on ten leaves/plot. Five assessments were conducted: 0 DBA, 3 DAA, 8 DAA, 15 DAA and 21 DAA.

TABLE 8
Effect of the combination of glycine betaine and acetamiprid on
immature white fly incidence (% of leaves with at least 1 insect)

| | 0DAA | | | | | | |
|---|---|---|---|---|---|---|---|
| | (number | | | | | | |
| | of leaves | | | | | | |
| | with at | | | | | | |
| Incidence | least 1 | | | | | | |
| immature | insect/25 | | | | | SUM | Increase |
| Abbott | leaves) | 3DAA | 8DAA | 15DAA | 21DAA | efficacy | % |
| Untreated | 21 | 30 | 33 | 31 | 37 | | |
| (number of | | | | | | | |
| leaves with | | | | | | | |
| at least 1 | | | | | | | |
| insect/25 | | | | | | | |
| leaves) | | | | | | | |
| Epik SL | 22 | 46.88 | 61.79 | 66.52 | 72.08 | 247.27 | |
| 2.0 l/ha | | | | | | | |
| Epik SL 2 | 18 | 56.25 | 74.73 | 87.05 | 81.32 | 299.35 | 21.06 |
| l/ha + GB | | | | | | | |
| 300 g/ha | | | | | | | |
| Epik SL | 22 | 40.63 | 57.23 | 50.89 | 53.33 | 202.08 | |
| 1.0 l/ha | | | | | | | |
| Epik SL 1 | 25 | 29.91 | 54.29 | 60.71 | 62.36 | 207.27 | 2.57 |
| l/ha + GB | | | | | | | |
| 300 g/ha | | | | | | | |
| Epik SL | 23 | 27.23 | 38.84 | 33.93 | 37.85 | 137.85 | |
| 0.5 l/ha | | | | | | | |
| Epik SL | 19 | 43.3 | 54.73 | 50.89 | 48.06 | 196.98 | 42.89 |
| 0.5 l/ha + | | | | | | | |
| GB 300 | | | | | | | |
| g/ha | | | | | | | |

TABLE 9
Effect of the combination of glycine betaine and acetamiprid on
adult white fly incidence (% of leaves with at least 1 insect)

| | 0DAA | | | | | | |
|---|---|---|---|---|---|---|---|
| | (number | | | | | | |
| | of leaves | | | | | | |
| | with at | | | | | | |
| Incidence | least 1 | | | | | | |
| adults | insect/25 | | | | | SUM | Increase |
| Abbott | leaves) | 3DAA | 8DAA | 15DAA | 21DAA | efficacy | % |
| Untreated | 60 | 59 | 66 | 62 | 51 | | |
| (number of | | | | | | | |
| leaves with | | | | | | | |
| at least 1 | | | | | | | |
| insect/25 | | | | | | | |
| leaves) | | | | | | | |
| Epik SL | 58 | 39.82 | 66.04 | 79.07 | 66.1 | 251.03 | |
| 2.0 l/ha | | | | | | | |
| Epik SL 2 | 69 | 37.94 | 66.88 | 77.3 | 70.14 | 252.26 | 0.49 |
| l/ha + GB | | | | | | | |
| 300 g/ha | | | | | | | |
| Epik SL | 67 | 26.23 | 55.73 | 59.33 | 46.91 | 188.2 | |
| 1.0 l/ha | | | | | | | |
| Epik SL 1 | 64 | 36.02 | 66.04 | 72.27 | 64.47 | 238.8 | 26.89 |
| l/ha + GB | | | | | | | |
| 300 g/ha | | | | | | | |
| Epik SL | 65 | 10.07 | 43.33 | 35.66 | 12.28 | 101.34 | |
| 0.5 l/ha | | | | | | | |
| Epik SL | 59 | 36.81 | 47.92 | 58.75 | 29.8 | 173.28 | 70.99 |
| 0.5 l/ha + | | | | | | | |
| GB 300 | | | | | | | |
| g/ha | | | | | | | |

TABLE 10
Effect of the combination of glycine betaine and acetamiprid on
the severity of mortality of immature white flies (Abbott %)

| | 0DAA | | | | | | |
|---|---|---|---|---|---|---|---|
| | (number | | | | | | |
| | of | | | | | | |
| Severity | insects | | | | | | |
| immature | in 25 | | | | | SUM | Increase |
| Abbott | leaves) | 3DAA | 8DAA | 15DAA | 21DAA | efficacy | % |
| Untreated (number | 1.19 | 1.36 | 1.46 | 1.36 | 1.2 | | |
| of insects in 25 leaves) | | | | | | | |
| Epik SL 2.0 l/ha | 1.3 | 49.69 | 74.15 | 79.28 | 80.88 | 284 | |
| Epik SL 2 l/ha + | 1.23 | 54.16 | 88.01 | 94.2 | 91.61 | 327.98 | 15.49 |
| GB 300 g/ha | | | | | | | |
| Epik SL 1.0 l/ha | 0.96 | 51.32 | 70.62 | 70.41 | 72.69 | 265.04 | |
| Epik SL 1 l/ha + | 1.14 | 53.29 | 73.45 | 77.76 | 78.56 | 283.06 | 6.80 |
| GB 300 g/ha | | | | | | | |
| Epik SL 0.5 l/ha | 1.56 | 13.31 | 39.72 | 43.23 | 33.88 | 130.14 | |
| Epik SL 0.5 l/ha + | 1.23 | 31.56 | 53.48 | 55.57 | 44.45 | 185.06 | 42.20 |
| GB 300 g/ha | | | | | | | |

TABLE 11
Effect of the combination of glycine betaine and acetamiprid
on the severity of mortality of adult white flies (Abbott %)

| | 0DAA | | | | | | |
|---|---|---|---|---|---|---|---|
| | (number | | | | | | |
| Severity | of insects | | | | | | |
| adults | in 25 | | | | | SUM | Increase |
| Abbott | leaves) | 3DAA | 8DAA | 15DAA | 21DAA | efficacy | % |
| Untreated | 3.35 | 3.56 | 3.78 | 4.04 | 2.68 | | |
| (number of | | | | | | | |
| insects in 25 | | | | | | | |
| leaves) | | | | | | | |
| Epik SL | 3.01 | 56.72 | 80.18 | 89.72 | 87.62 | 314.24 | |
| 2.0 l/ha | | | | | | | |
| Epik SL 2 | 3.29 | 60.52 | 83.4 | 93.84 | 91.68 | 329.44 | 4.84 |
| l/ha + GB | | | | | | | |
| 300 g/ha | | | | | | | |
| Epik SL | 3.13 | 36.8 | 66.17 | 80.72 | 78.43 | 262.12 | |
| 1.0 l/ha | | | | | | | |
| Epik SL 1 | 3.16 | 48.3 | 75.33 | 86.91 | 84.34 | 294.88 | 12.50 |
| l/ha + GB | | | | | | | |
| 300 g/ha | | | | | | | |
| Epik SL | 3.69 | 20.17 | 47.29 | 50.23 | 50.5 | 168.19 | |
| 0.5 l/ha | | | | | | | |
| Epik SL | 3.58 | 37.46 | 54.19 | 70.45 | 58.3 | 220.4 | 31.04 |
| 0.5 l/ha + | | | | | | | |
| GB 300 | | | | | | | |
| g/ha | | | | | | | |

TABLE 12
Effect of the addition of glycine betaine to acetamiprid on whiteflies mortality at each of the assessment performed

| | Assessment | High dose | | | | Medium dose | | | | Low dose | | | | Average |
|---|---|---|---|---|---|---|---|---|---|---|---|---|---|---|
| Target | type | 1 ass | 2 ass | 3 ass | 4 ass | 1 ass | 2 ass | 3 ass | 4 ass | 1 ass | 2 ass | 3 ass | 4 ass | % of+ |
| + | Incidence | − | + | − | + | + | + | + | + | + | + | + | + | 83% |
| WF | Incidence | + | + | + | + | − | − | + | + | + | + | + | + | 83% |
| Immature | | | | | | | | | | | | | | |
| WF | N. insects | + | + | + | + | + | + | + | + | + | + | + | + | 100% |
| Adults | | | | | | | | | | | | | | |
| WF | N. insects | + | + | + | + | + | + | + | + | + | + | + | + | 100% |
| Immature | | | | | | | | | | | | | | |
| | | | | | | | | | | | | | | 92% |

“+” means that an improvement of the efficacy has been observed;
“=” means that no improvement in efficacy has been observed;
and “−” means that a negative effect has been observed.

As demonstrated in the above results (see Tables 8 to 12), the addition of glycine betaine to acetamiprid improved the effect of acetamiprid compared to the insecticidal activity when acetamiprid is used alone. Further, the results presented in Table 12 indicate that an improvement of the insecticide activity by the addition of glycine betaine was observed in 92% of the assessments done, all treatments taken together.

### Example 4: Combination of Glycine Betaine and Acetamiprid Against Aphids

Tests were conducted to study the efficacy of the addition of glycine betaine to acetamiprid in tank mix against aphids (Myzus persicae) on peaches. The trials were conducted under field conditions.

Field assessments were done before application of the treatment (0 DAA) to record pest population and create the blocks according to the infestation.

Trees were sprayed with a combination of glycine betaine (Intracell, Lallemand) and acetamiprid (Epik SL, Sipcam) at BBCH 72 (Green ovary surrounded by dying sepal crown, sepals beginning to fall).

The trials were set up in a fully randomized block design with 4 replicates and the untreated control, included. Each plot contained at least 2 trees. The following sprayable treatments were tested: (1) untreated; (2) Epik 2 l/ha (higher dose that could be used based on recommendations); (3) Epik 2 l/ha+glycine betaine 300 g/ha; (4) Epik 1 l/ha (50% of recommended dose); (5) Epik 1 l/ha+glycine betaine 300 g/ha; (6) Epik 0.5 l/ha (20% of recommended dose); or (7) Epik 0.5 l/ha+glycine betaine 300 g/ha.

Green peach aphids (Myzus persicae) and aphids (Aphis sp.) were recorded on 25 labelled shoots per plot at each assessment timing (pre-flowering application: 0DAA, 7-10 DAA and 21 DAA and post-flowering application: 0 DAA, 1-3 DAA, 7-10 DAA, 14 DAA and 21 DAA).

TABLE 13
Effect of the combination of glycine betaine and acetamiprid on aphid mortality

| | 0DAA | | | | | | |
|---|---|---|---|---|---|---|---|
| | (n. of | | | | | | |
| | insect | | | | | | |
| Insect control | in 25 | | | | | SUM | increase |
| Abbott | shoots) | 1DAA | 7DAA | 14DAA | 21DAA | efficacy | % |
| Untreated (n. of | 0.8 | 0.85 | 0.99 | 1.14 | 1.4 | | |
| insect in 25 | | | | | | | |
| shoots) | | | | | | | |
| Epik SL 2.0 l/ha | 0.2 | 95.33 | 100 | 100 | 81.47 | 376.8 | |
| Epik SL 2 l/ha + | 0.7 | 98.49 | 100 | 100 | 85.71 | 384.2 | 1.96 |
| GB 300 g/ha | | | | | | | |
| Epik SL 1.0 l/ha | 0.5 | 88.93 | 96.88 | 100 | 76.79 | 362.6 | |
| Epik SL 1 l/ha + | 0.4 | 91.09 | 100 | 100 | 78.2 | 369.29 | 1.85 |
| GB 300 g/ha | | | | | | | |
| Epik SL 0.5 l/ha | 0.7 | 56.99 | 88.07 | 95.59 | 64.77 | 305.42 | |
| Epik SL 0.5 l/ha + | 0.6 | 62.51 | 91.14 | 97.6 | 68.01 | 319.26 | 4.53 |
| GB 300 g/ha | | | | | | | |

TABLE 14
Effect of the addition of glycine betaine to acetamiprid on aphids mortality at each of the assessment performed

| | Assessment | High dose | | | | Medium dose | | | | Low dose | | | | Average |
|---|---|---|---|---|---|---|---|---|---|---|---|---|---|---|
| Target | type | 1 ass | 2 ass | 3 ass | 4 ass | 1 ass | 2 ass | 3 ass | 4 ass | 1 ass | 2 ass | 3 ass | 4 ass | % of+ |
| Adults | Insects | + | = | = | + | + | + | = | + | + | + | + | + | 75% |

“+” means that an improvement of the efficacy has been observed;
“=” means that no improvement in efficacy has been observed;
and “−” means that a negative effect has been observed.

The results show in Tables 13 and 14 that an addition of glycine betaine to acetamiprid made the control measures against aphids more effective compared to the use of acetamiprid alone. Further, the results presented in Table 14 indicate that an improvement of the insecticide activity by the addition of glycine betaine was observed in 75% of the assessments done, all treatments taken together.

### Example 5: Combination of Glycine Betaine and Abamectine Against Tetranychus urticae

Tests were conducted to study the efficacy of the addition of glycine betaine to abamectine in tank mix against two-spotted spider mite (Tetranychus urticae) on tomatoes. The trials were conducted in greenhouse.

Plants were sprayed with a combination of glycine betaine (Intracell, Lallemand) and abamectine (Vertimec EC, Syngenta) at BBCH 59 (9 or more inflorescences visible).

The trials were set up in a fully randomized block design with 4 replicates and the untreated control, included. Each plot contained ten plants. The following sprayable treatments were tested: (1) untreated; (2) Vertimec 0.6 l/ha (higher dose that could be used based on recommendations); (3) Vertimec 0.6 l/ha+glycine betaine 300 g/ha; (4) Vertimec 0.3 l/ha (50% of recommended dose); (5) Vertimec 0.3 l/ha+glycine betaine 300 g/ha; (6) Vertimec 0.12 l/ha (20% of recommended dose); or (7) Vertimec 0.12 l/ha+glycine betaine 300 g/ha.

Nymphs and adults T. urticae were evaluated on 10 labelled leaves (one leaf per plant) per plot. Number of eggs, nymphs and adults were assed separately. Four assessments were conducted: 0 DBA, 2-3 DAA, 7-10 DAA and 14-21 DAA.

TABLE 15
Effect of the combination of glycine betaine and abamectine
on the mortality of T. urticae nymphs (Abbott %)

| Nymphs | | | | | | |
|---|---|---|---|---|---|---|
| Abbott | 0DAA | | | | | |
| (individuals | (number of | | | | | |
| in 10 | individuals in | | | | SUM | |
| leaves) | 10 leaves) | 2DAA | 7DAA | 14DAA | efficacy | Increase % |
| Untreated | 1.9 | 1.6 | 1.5 | 1.1 | | |
| (number of | | | | | | |
| individuals in | | | | | | |
| 10 leaves) | | | | | | |
| Vertimec | 1.6 | 48.73 | 71.56 | 100 | 220.29 | |
| 0.6 l/ha | | | | | | |
| Vertimec | 2 | 52.02 | 76.58 | 100 | 228.6 | 3.77 |
| 0.6 l/ha + | | | | | | |
| GB 300 | | | | | | |
| g/ha | | | | | | |
| Vertimec | 1.6 | 35.82 | 50.54 | 51.77 | 138.13 | |
| 0.3 l/ha | | | | | | |
| Vertimec | 1.8 | 40.3 | 49.99 | 75.3 | 165.59 | 19.88 |
| 0.3 l/ha + | | | | | | |
| GB 300 | | | | | | |
| g/ha | | | | | | |

TABLE 16
Effect of the combination of glycine betaine and abamectine
on the mortality of T. urticae adults

| Adults | | | | | | |
|---|---|---|---|---|---|---|
| Abbott | 0DAA | | | | | |
| (individuals | (number of | | | | | |
| in 10 | individuals in | | | | SUM | |
| leaves) | 10 leaves) | 2DAA | 7DAA | 14DAA | efficacy | Increase % |
| Untreated | 1.5 | 2.2 | 2.5 | 3 | | |
| (number of | | | | | | |
| individuals in | | | | | | |
| 10 leaves) | | | | | | |
| Vertimec | 1.5 | 61.69 | 89.62 | 98 | 249.31 | |
| 0.6 l/ha | | | | | | |
| Vertimec | 1.6 | 75.06 | 81.33 | 98 | 254.39 | 2.04 |
| 0.6 l/ha + | | | | | | |
| GB 300 | | | | | | |
| g/ha | | | | | | |
| Vertimec | 1.6 | 62.96 | 71.46 | 91.32 | 225.74 | |
| 0.3 l/ha | | | | | | |
| Vertimec | 1.3 | 59.01 | 79.94 | 93 | 231.95 | 2.75 |
| 0.3 l/ha + | | | | | | |
| GB 300 | | | | | | |
| g/ha | | | | | | |
| Vertimec | 1.5 | 36.52 | 67.22 | 85.76 | 189.5 | |
| 0.12 l/ha | | | | | | |
| Vertimec | 1.6 | 45.71 | 68.24 | 89.22 | 203.17 | 7.21 |
| 0.12 l/ha + | | | | | | |
| GB 300 | | | | | | |
| g/ha | | | | | | |

TABLE 17
Effect of the addition of glycine betaine to abamectine on two-spotted
spider mite mortality at each of the assessment performed

| | Assessment | High dose | | | Medium dose | | | Low dose | | | Average |
|---|---|---|---|---|---|---|---|---|---|---|---|
| Target | type | 1 ass | 2 ass | 3 ass | 1 ass | 2 ass | 3 ass | 1 ass | 2 ass | 3 ass | % of+ |
| Mites | Adults | + | − | = | − | + | + | + | + | + | 66.7% |
| | Nymphs | + | + | = | + | − | + | − | − | + | 55.6% |

“+” means that an improvement of the efficacy has been observed;
“=” means that no improvement in efficacy has been observed;
and “−” means that a negative effect has been observed.

As shown in Tables 15 to 17, the results demonstrate that an addition of glycine betaine to abamectine made the control measures against T. urticae more effective compared to the use of abamectine alone. Further, the results presented in Table 17 indicate that an improvement of the acaricide activity by the addition of glycine betaine was observed in 66.7 and 55.6% of the assessments done.

While the invention has been described in connection with specific embodiments thereof, it will be understood that the scope of the claims should not be limited by the preferred embodiments set forth in the examples, but should be given the broadest interpretation consistent with the description as a whole.

Further aspects of the invention:
1. A method for controlling a pest or protecting a plant from a pest, said method comprising contacting soil, a pest, a plant or a plant part with (a) at least one insecticide, acaricide and/or nematicide and (b) glycine betaine.
2. A method for enhancing the efficacy of at least one insecticide, acaricide and/or nematicide, said method comprising contacting soil, a pest, a plant or a plant part with (a) at least one insecticide, acaricide and/or nematicide and (b) glycine betaine.
3. The method of aspect 1 or 2, wherein upon contact of the at least one insecticide, acaricide and/or nematicide and glycine betaine to soil, the pest, the plant or the plant part, the at least one insecticide, acaricide and/or nematicide exhibits an increased pest control compared to contacting the at least one insecticide, acaricide and/or nematicide to soil, the pest, the plant or the plant part without glycine betaine.
4. A method for manufacturing a composition which comprises mixing (a) at least one insecticide, acaricide and/or nematicide and (b) glycine betaine to obtain a composition comprising (a) at least one insecticide, acaricide and/or nematicide and (b) glycine betaine.
5. The method of aspect 4, wherein said method further comprising mixing the (a) at least one insecticide, acaricide and/or nematicide and (b) glycine betaine with (c) a carrier to obtain a composition comprising (a) at least one insecticide, acaricide and/or nematicide, (b) glycine betaine and (c) the carrier.
6. The method of aspect 4 or 5, wherein said composition is for controlling a pest.
7. A composition for controlling a plant pest, wherein the composition comprises (a) at least one insecticide, acaricide and/or nematicide; and (b) glycine betaine.
8. The composition of aspect 7, which further comprises (c) a carrier.
9. Use of an effective amount of (a) at least one insecticide, acaricide and/or nematicide and (b) glycine betaine.
10. The use of aspect 9, wherein the use enhances the insecticidal, acaricidal and/or nematicidal activity of the at least one insecticide, acaricide and/or nematicide compared to the insecticidal, acaricidal and/or nematicidal activity of the at least one insecticide, acaricide and/or nematicide when used without glycine betaine.
11. The method of any one of aspects 1 to 6, the composition of aspect 7 or 8 or the use of aspect 9 or 10, wherein said at least one insecticide, acaricide and/or nematicide is Abamectin, Acephate, Acetamiprid, Acrinathrin, Alpha-Cypermethrin, Beta-Cyfluthrin, Bifenthrin, Buprofezin, Clothianidin, Chlorantraniliprole, Chlorfenapyr, Chlorpyrifos, Carbofuran, Cyantraniliprole, Cyenopyrafen, Cyflumentofen, Cyfluthrin, Cypermethrin, Deltamethrin, Diafenthiuron, Dinotefuran, Emamectin-benzoate, Ethiprole, Fenpyroximate, Fipronil, Flometoquin, Flubendiamide, Fluensulfone, Fluopyram, Flupyradifurone, Gamma-Cyhalothrin, Imidacloprid, Indoxacarb, Lambda-Cyhalothrin, Lufenuron, Metaflumizone, Methiocarb, Methoxyfenozide, Milbemectin, Profenofos, Pyflubumide, Pyrifluquinazone, Spinetoram, Spinosad, Spirodiclofen, Spiromesifen, Spirotetramate, Sulfoxaflor, Tebufenpyrad, Tefluthrin, Thiacloprid, Thiamethoxam, Thiodicarb, Triflumuron, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, 1-{2-fluoro-4-methyl-5-[(2,2,2-trifluorethyl)sulfinyl]phenyl}-3-(trifluoromethyl)-1H-1,2,4-triazol-5-amine or Afidopyropen.
12. The method of any one of aspects 1 to 6 or 11, the composition of aspect 7, 8 or 11 or the use of any one of aspects 9 to 11, wherein
(i) the at least one insecticide, acaricide and/or nematicide is abamectin;
(ii) the at least one insecticide, acaricide and/or nematicide is acetamiprid; or
(iii) the at least one insecticide, acaricide and/or nematicide is flupyradifurone.
13. The method of any one of aspects 1 to 6, 11 or 12, the composition of any one of aspects 7, 8, 11 or 12 or the use of any one of aspects 9 to 12, wherein the pest is an insect pest or a mite pest, optionally wherein said insect pest belongs to the species Dysaphis plantaginea, Trialeurodes vaporariorum or Myzus persicae, or optionally wherein said mite pest belongs to the species Tetranychus urticae.
14. The method of any one of aspects 1 to 6 and 11 to 13 or the use of any one of aspects 7, 8 and 11 to 13, wherein said (a) at least one insecticide, acaricide and/or nematicide and (b) glycine betaine are used simultaneously or sequentially.
15. The method of any one of aspects 1 to 6 and 11 to 14, the composition of any one of aspects 7, 8 and 11 to 13 or the use of any one of aspects 7, 8 and 11 to 14, wherein said glycine betaine is applied to soil, a pest, a plant or a plant part at a concentration of between about 0.02% to 95% (weight/weight).
16. The method of any one of aspects 1 to 6 and 11 to 15, the composition of any one of aspects 7, 8 and 11 to 13 or the use of any one of aspects 7, 8 and 11 to 15, wherein
(i) the at least one insecticide, acaricide and/or nematicide is abamectin and glycine betaine is present at a concentration of between about 20% and 80% (w/w);
(ii) the at least one insecticide, acaricide and/or nematicide is acetamiprid and glycine betaine is present at a concentration of between about 10% and 45% (w/w); or
(iii) the at least one insecticide, acaricide and/or nematicide is flupyradifurone and glycine betaine is present at a concentration of between about 30% and 75% (w/w).

1-32. (canceled)

33. A method for:
(i) controlling a pest or protecting a plant from a pest, said method comprising contacting soil, a pest, a plant and/or a plant part with at least one insecticide, acaricide and/or nematicide and glycine betaine; or
(ii) enhancing the efficacy of at least one insecticide, acaricide and/or nematicide, said method comprising contacting soil, a pest, a plant and/or a plant part with at least one insecticide, acaricide and/or nematicide and glycine betaine; or
(iii) reducing an amount of at least one insecticide, acaricide and/or nematicide applied to soil, a pest, a plant and/or a plant part needed to control a pest, comprising applying to the soil, the pest, the plant and/or the plant part the at least one insecticide, acaricide and/or nematicide in combination with glycine betaine.

34. The method of claim 33 (i) or 33 (ii), wherein the method exhibits an increased pest control compared to a method comprising contacting the at least one insecticide, acaricide and/or nematicide to soil, the pest, the plant and/or the plant part without glycine betaine.

35. The method of claim 33 (iii), wherein the amount of the at least one insecticide, acaricide and/or nematicide applied is less than an amount of the at least one insecticide, acaricide and/or nematicide needed to control the pest in the absence of glycine betaine.

36. The method of claim 33 (iii), wherein the amount of the at least one insecticide, acaricide and/or nematicide applied is less than a recommended dose of the at least one insecticide, acaricide and/or nematicide applied alone, and wherein the method achieves substantially the same or greater insecticidal, acaricidal and/or nematicidal effect as compared to a method applying the recommended dose of the at least one insecticide, acaricide and/or nematicide alone.

37. The method of claim 33, comprising applying the at least one insecticide, acaricide and/or nematicide to the soil, the pest, the plant and/or the plant part.

38. A composition for controlling a plant pest, wherein the composition comprises (i) at least one insecticide, acaricide and/or nematicide; and (ii) glycine betaine.

39. The composition of claim 38, wherein the composition further comprises a carrier.

40. The composition of claim 38, wherein the amount of the at least one insecticide, acaricide and/or nematicide is less than an amount of the at least one insecticide, acaricide and/or nematicide needed to control a pest in the absence of glycine betaine.

41. The method of claim 33, wherein:
(a) the at least one insecticide, acaricide and/or nematicide is a synthetic insecticide, acaricide and/or nematicide; or
(b) the at least one insecticide, acaricide and/or nematicide is an externally applied insecticide, acaricide and/or nematicide; or
(c) the at least one insecticide, acaricide and/or nematicide has a molecular weight of less than 10000 daltons, optionally wherein the molecular weight of the at least one insecticide, acaricide and/or nematicide is less than 5000 daltons, such as less than 2500 daltons, less than 1000 daltons, less than 750 daltons or less than 500 daltons; or
(d) the at least one insecticide, acaricide and/or nematicide is not a polypeptide; or
(e) the at least one insecticide, acaricide and/or nematicide is selected from Abamectin, Acephate, Acetamiprid, Acrinathrin, Alpha-Cypermethrin, Beta-Cyfluthrin, Bifenthrin, Buprofezin, Clothianidin, Chlorantraniliprole, Chlorfenapyr, Chlorpyrifos, Carbofuran, Cyantraniliprole, Cyenopyrafen, Cyflumentofen, Cyfluthrin, Cypermethrin, Deltamethrin, Diafenthiuron, Dinotefuran, Emamectin-benzoate, Ethiprole, Fenpyroximate, Fipronil, Flometoquin, Flubendiamide, Fluensulfone, Fluopyram, Flupyradifurone, Gamma-Cyhalothrin, Imidacloprid, Indoxacarb, Lambda-Cyhalothrin, Lufenuron, Metaflumizone, Methiocarb, Methoxyfenozide, Milbemectin, Profenofos, Pyflubumide, Pyrifluquinazone, Spinetoram, Spinosad, Spirodiclofen, Spiromesifen, Spirotetramate, Sulfoxaflor, Tebufenpyrad, Tefluthrin, Thiacloprid, Thiamethoxam, Thiodicarb, Triflumuron, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, 1-{2-fluoro-4-methyl-5-[(2,2,2-trifluorethyl)sulfinyl]phenyl}-3-(trifluoromethyl)-1H-1,2,4-triazol-5-amine or Afidopyropen; or
(f) the at least one insecticide, acaricide and/or nematicide is abamectin; or
(g) the at least one insecticide, acaricide and/or nematicide is acetamiprid; or
(h) the at least one insecticide, acaricide and/or nematicide is flupyradifurone.

42. The method of claim 33, wherein the pest is an insect pest of the Order Hemiptera or Homoptera, or a mite pest, optionally wherein the insect pest belongs to the species selected from Dysaphis plantaginea, Trialeurodes vaporariorum or Myzus persicae, and optionally wherein the mite pest belongs to the species Tetranychus urticae.

43. The method of claim 33, wherein:
(a) the at least one insecticide, acaricide and/or nematicide is contacted with a plant or a plant part, wherein the plant is a tree, a fruit or a vegetable; or
(b) the at least one insecticide, acaricide and/or nematicide and the glycine betaine are applied simultaneously or sequentially; or
(c) the glycine betaine is applied to soil, a pest, a plant or a plant part at a concentration of between about 0.02% to 95% (weight/weight); or
(d) the at least one insecticide, acaricide and/or nematicide is abamectin; and
the glycine betaine is present at a concentration of between about 20% and 80% (w/w); or
(e) the at least one insecticide, acaricide and/or nematicide is acetamiprid; and
glycine betaine is present at a concentration of between about 10% and 45% (w/w); or
(f) the at least one insecticide, acaricide and/or nematicide is flupyradifurone;
and glycine betaine is present at a concentration of between about 30% and 75% (w/w).

44. The composition of claim 38, wherein:
(a) the at least one insecticide, acaricide and/or nematicide is a synthetic insecticide, acaricide and/or nematicide; or
(b) the at least one insecticide, acaricide and/or nematicide is an externally applied insecticide, acaricide and/or nematicide; or
(c) the at least one insecticide, acaricide and/or nematicide has a molecular weight of less than 10000 daltons, optionally wherein the molecular weight of the at least one insecticide, acaricide and/or nematicide is less than 5000 daltons, such as less than 2500 daltons, less than 1000 daltons, less than 750 daltons or less than 500 daltons; or
(d) the at least one insecticide, acaricide and/or nematicide is not a polypeptide; or
(e) the at least one insecticide, acaricide and/or nematicide is selected from Bifenthrin, Buprofezin, Clothianidin, Chlorantraniliprole, Chlorfenapyr, Chlorpyrifos, Carbofuran, Cyantraniliprole, Cyenopyrafen, Cyflumentofen, Cyfluthrin, Cypermethrin, Deltamethrin, Diafenthiuron, Dinotefuran, Emamectin-benzoate, Ethiprole, Fenpyroximate, Fipronil, Flometoquin, Flubendiamide, Fluensulfone, Fluopyram, Flupyradifurone, Gamma-Cyhalothrin, Imidacloprid, Indoxacarb, Lambda-Cyhalothrin, Lufenuron, Metaflumizone, Methiocarb, Methoxyfenozide, Milbemectin, Profenofos, Pyflubumide, Pyrifluquinazone, Spinetoram, Spinosad, Spirodiclofen, Spiromesifen, Spirotetramate, Sulfoxaflor, Tebufenpyrad, Tefluthrin, Thiacloprid, Thiamethoxam, Thiodicarb, Triflumuron, 1-(3-chloropyridin-2-yl)-N-[4-cyano-2-methyl-6-(methylcarbamoyl)phenyl]-3-{[5-(trifluoromethyl)-1H-tetrazol-1-yl]methyl}-1H-pyrazole-5-carboxamide, 1-(3-chloropyridin-2-yl)-N-[4-cyano-2-methyl-6-(methylcarbamoyl)phenyl]-3-{[5-(trifluoromethyl)-2H-tetrazol-2-yl]methyl}-1H-pyrazole-5-carboxamide, 1-{2-fluoro-4-methyl-5-[(2,2,2-trifluorethyl)sulfinyl]phenyl}-3-(trifluoromethyl)-1H-1,2,4-triazol-5-amine or Afidopyropen; or
(f) the at least one insecticide, acaricide and/or nematicide is abamectin; or
(g) the at least one insecticide, acaricide and/or nematicide is acetamiprid; or
(h) the at least one insecticide, acaricide and/or nematicide is flupyradifurone.

45. The composition of claim 38, wherein the pest is an insect pest of the Order Hemiptera or Homoptera, or a mite pest, optionally wherein the insect pest belongs to the species selected from Dysaphis plantaginea, Trialeurodes vaporariorum and Myzus persicae, and optionally wherein the mite pest belongs to the species Tetranychus urticae.

46. The composition of claim 38, wherein:
(a) said glycine betaine is applied to soil, a pest, a plant or a plant part at a concentration of between about 0.02% to 95% (weight/weight); or
(b) the at least one insecticide, acaricide and/or nematicide is abamectin; and the glycine betaine is present at a concentration of between about 20% and 80% (w/w); or
(c) the at least one insecticide, acaricide and/or nematicide is acetamiprid; and the glycine betaine is present at a concentration of between about 10% and 45% (w/w); or
(d) the at least one insecticide, acaricide and/or nematicide is flupyradifurone; and the glycine betaine is present at a concentration of between about 30% and 75% (w/w).

47. A method:
(i) for manufacturing a composition comprising mixing (a) at least one insecticide, acaricide and/or nematicide and (b) glycine betaine to obtain a composition comprising at least one insecticide, acaricide and/or nematicide and glycine betaine; or
(ii) of formulating a composition for controlling a pest or protecting a plant from a pest, the method comprising: mixing glycine betaine and at least one insecticide, acaricide and/or nematicide, wherein the amount of the at least one insecticide, acaricide and/or nematicide in the composition is less than the amount of the at least one insecticide, acaricide and/or nematicide needed to control the pest or protect the plant from the pest in the absence of glycine betaine.

48. The method of claim 47, wherein the method further comprises mixing a carrier to manufacture or formulate a composition comprising (a) at least one insecticide, acaricide and/or nematicide, (b) glycine betaine and (c) the carrier.

49. The method of claim 47, wherein the composition is for controlling a pest.

50. The method of claim 49, wherein an amount of the at least one insecticide, acaricide and/or nematicide needed to control the pest is less than an amount of the at least one insecticide, acaricide and/or nematicide needed to control the pest in the absence of glycine betaine.

51. The method of claim 47, further comprising:
determining an amount of the at least one insecticide, acaricide and/or nematicide needed to control the pest or protect the plant from the pest in the absence of glycine betaine;
determining an amount of the at least one insecticide, acaricide and/or nematicide needed to control the pest or protect the plant from the pest in the presence of glycine betaine; and/or
comparing the amount of the at least one insecticide, acaricide and/or nematicide needed to control the pest or protect the plant from the pest in the absence of glycine betaine to the amount of the at least one insecticide, acaricide and/or nematicide needed to control the pest or protect the plant from the pest in the presence of glycine betaine.
